(19) United States
(12) Patent Application Publication
(10) Pub. No.: US 2015/0298391 A1
(43) Pub. Date: Oct. 22, 2015

(54) Method for joining a joining partner of a thermoplastic material to a joining partner of glass

(71) Applicant: LPKF Laser & Electronics AG, Garbsen (DE)

(72) Inventors: Frank Brunnecker, Memmelsdorf (DE); Manuel Sieben, Fürth-Vach (DE); Tobias Jaus, Nürnberg (DE)

(21) Appl. No.: 14/440,966

(22) PCT Filed: Nov. 6, 2013
(86) PCT No.: PCT/EP2013/073125

§ 371 Date: May 6, 2015

(30) Foreign Application Priority Data
Nov. 7, 2012 (DE) 10 2012 220 285.4

(51) Int. Cl. B29C 65/16; B32B 37/18; B29C 65/14; B32B 38/00; B29C 65/44; B29C 65/72; B32B 37/04; B32B 37/06

(52) U.S. Cl. CPC B29C 65/16; B32B 37/04; B32B 37/182; B32B 37/06; B32B 38/0008; B29C 65/44; B29C 65/72; B29C 65/14; B32B 2457/20; B32B 2307/412; B29L 2031/3475

(57) ABSTRACT

A method for joining a joining partner made of a thermoplastic material to a joining partner made of glass is provided. The method includes providing a thermoplastic joining partner made of a laser-absorbing thermoplastic material, providing a glass joining partner made of a laser-transmissive glass material, placing the thermoplastic joining partner and the glass joining partner on top of each other while applying a joining force to the joining partners, increasing the temperature of the glass joining partner, in particular using a radiation, and emitting a laser processing beam through the glass joining partner onto the boundary surface of the thermoplastic joining partner and into a joining zone, thus causing the thermoplastic joining partner to melt so as to form an adhesive bond between the two joining partners in the joining zone during the cooling thereof.

### CROSS-REFERENCE TO RELATED APPLICATIONS

This application claims the priority of German Patent Application, Serial No. DE 10 2012 220 285.4, filed on 7 Nov. 2012, pursuant to 35 U.S.C. 119(a)-(d), the content of which is incorporated herein by reference in its entirety as if fully set forth herein.

### FIELD OF THE INVENTION

The invention relates to a method for joining a joining partner of a thermoplastic material to a joining partner of glass.

### BACKGROUND OF THE INVENTION

With regard to the background of the invention, it shall be noted that presently, glass-plastic joints are typically produced using adhesives. Examples thereof are for instance mobile phone displays made of a glass material joined to a PC or PC/ABS casing. In a first step, the adhesive is applied while in a second step, the glass panel is placed thereupon. In this process, there is a huge risk for escaping adhesive to cause a “short-circuit” between the ITO layers disposed on the glass, thus causing irreversible damage to the touch screen. In addition to this risk of producing rejects, another drawback of this technique is that the joints do not have a pleasing appearance and need to be covered by a black print on the display.

Other applications for this bonding technique include vehicle glazings used in the automotive industry, such as sunroofs in a plastic carrier. In this field, the thermoplastic joining partner is preferably made of PP for economical reasons. Due to its non-polar structure, PP is unable to form adhesive bonds unless corresponding treatments are applied thereto, which results in additional costs.

A third field of application are control devices/frequency converters attached directly to the back of a substrate of photovoltaic solar panels. EP 1 763 431 B1 relates to a method for laser welding of a thermoplastic polymer material to a second material transmissive of the laser light used, wherein for laser welding, the laser light is, at the welding spot, emitted through the second material and onto the first material, with at least the first material softening at the welding spot under the influence of the laser light. The second material according to EP 1 763 431 B1 may be a non-softening material to which the softened first material adheres after curing. For instance, the method for laser welding according to EP 1 763 431 B1 allows a thermoplastic polymer material (first material) to be joined to glass.

DE 10 2009 034 226 A1 relates to a production method for a lamp comprising an at least partly translucent component and a plastic component forming a lamp housing or a lamp base. In at least one joining spot, a surface-to-surface bond or positive bond is produced between the plastic component and the at least partly translucent component by melting at least the plastic component by means of a laser beam.

In an exemplary embodiment of DE 10 2009 034 226 A1, the at least partly translucent component of the lamp is made of glass. By melting the at least one joining spot of the plastic component, a positive bond is obtained between the plastic component and the glass component. In the method according to DE 10 2009 034 226 A1, the laser beam passes through the at least partly translucent component during melting, thus at first causing substantially the plastic component to heat up. The plastic component is preferably made of polycarbonate, polypropylene, acrylic nitrile butadiene styrene or polybutylene terephtalate.

JP 2011-207 056 A relates to a method for joining a thermoplastic material to a substrate material made of glass. The substrate material is, in the edge region thereof, welded to the plastic base body. In this process, a laser emits radiation through the substrate material, thus causing a contact surface of the plastic material to heat up. According to JP 2011-207 056 A, the plastic body is used as a base body while the substrate material of glass is used as a cover. In a region in which the substrate material is not welded to the plastic body, a semiconductor material is arranged between base body and substrate material.

While each of the documents cited above discloses the principle of laser induced hotmelt adhesive bonding, experiments conducted by the applicant in this field have shown, however, that the hotmelt adhesive bond lacks strength in particular due to stresses induced in the two different materials, namely a thermoplastic material and glass, when the joining partners cool off.

### SUMMARY OF THE INVENTION

The invention is now based on the object of providing a method for joining a joining partner made of a thermoplastic material to a joining partner of glass, the method allowing a reliable thermoplastic glass joint to be formed using simple procedural steps without requiring adhesives.

This object is achieved by the following method steps:
providing a thermoplastic joining partner of a laser-absorbing thermoplastic material,
providing a glass joining partner of a laser transmissive glass material,
placing the thermoplastic joining partner and the glass joining partner on top of each other while applying a joining force to the joining partners,
increasing the temperature of the glass joining partner using radiation, and
emitting a laser processing beam through the glass joining partner onto the boundary surface of the thermoplastic joining partner and into a joining zone, thus causing the thermoplastic joining partner to melt so that an adhesive bond is formed between the two joining partners in the joining zone during the cooling thereof.

In other words, the method according to the invention is based on the generally known laser transmission welding principle in which the processing beam is transmitted through a laser transmissive joining partner and onto the laser absorbing joining partner, thus causing the laser absorbing joining partner to melt and, in the case of a transmissive joining partner made of glass, adhere thereto in the melt region.

According to current knowledge, three different mechanisms of action are involved in the formation of adhesive bonds of this type. On the one hand, secondary valence bonds are formed in the molecule surfaces abutting against each other. This effect, which is primarily based on hydrogen bonds, has an effective distance of approximately 0.5 nm. It is therefore inevitable for one of the joining partners to be molten to compensate for surface irregularities. In addition thereto, the molten joining partner needs to be able to spread on the surface of the solid partner, in other words the surface tension should be as low as possible. On the other hand, this mechanism of action requires a polarity of the molten medium, in other words the surface tension needs to be unequal to zero. Optimally, the surface tension is selected such as to correspond to the essentially required amount of polar surface energy.

A second mechanism of action independent of polarity is the mechanical bond between the plasticized material and the surface structure of the solid joining partner. While this mechanism of action is independent of the polarity of the materials, it still requires a small amount of surface energy allowing the molten joining partner to spread thereon to the greatest possible extent.

A third potential mechanism of action is covalent bonding. While this bonding type provides for high adhesive forces, it is however necessary in many cases to functionalize the plastic surface. On the side of the glass, usually there are Si (silicon) molecules allowing covalent bonds in the form of SiOH (silanol) to develop. This means in turn that H (hydrogen) molecules need to be available on the surface of the thermoplastic material allowing this reaction to take place. These molecules may either be contained naturally in the plastic material or they may be introduced in a functionalizing process.

All mechanisms of action described above suffer from the fact that due to the much lower coefficient of thermal expansion of glass compared to that of the thermoplastic material, the hotmelt adhesive or bonding joint is deteriorated as due to the high contraction of the thermoplastic material in the joining zone, i.e. the hotmelt adhesive seam thus produced, internal stresses occur between the thermoplastic material and the glass. These stresses overlap with and reduce the adhesive forces thus produced to such an extent that in some joints, this caused the layers to separate from each other completely, which leads to the conclusion that the internal stresses in the seam exceed the adhesive forces produced.

This problem is solved by a temperature increase of the glass joining partner provided according to this process. By means of this measure, the temperature thereof is increased together with that of the thermoplastic joining partner, with the result that both joining partners show a more uniform cooling behavior and a considerably reduced development of internal stresses. Corresponding experiments show that this process allows reliable high-strength bonds to be created between the two joining partners mentioned above.

The material of the thermoplastic joining partner may for instance be selected from one or several of the following thermoplastic materials: polypropylene (PP), polyethylene (PE), acrylic nitrile butadiene styrene (ABS), acrylic ester styrene acrylic nitrile (ASA), polymethyl methacrylate (PMMA), polycarbonate (PC), polyehtylene terephtalate (PETE), polyethereimide (PEI), polyamide (PA) or cyclo olefin copolymer (COC).

Preferred materials for the glass joining partner are borosilicate glass, fused quartz, magnesium fluoride, hardened glass obtained by means of an ion exchange technique, or strengthened glass, preferably made of borosilicate glass.

The laser processing beam is preferably an infrared laser beam, in particular having a wavelength of 808 nm or 2000 nm, that may be provided at laser power of 10 W to 200 W. For this purpose, conventional laser beam processing installations can be used, for instance those produced and distributed by the applicant for applications such as laser transmission welding.

A preferred radiation source for heating up the glass joining partner may be formed by at least one halogen radiator emitting for instance a short-wave IR radiation at a power of between 500 W and 2000 W, preferably 1000 W. This relatively broadband secondary radiation, which can be emitted onto the glass joining partner before and/or simultaneously with the laser processing beam, causes the glass material to heat up intensively.

The strength of the bond between the thermoplastic joining partner and the glass joining partner may further be optimized in that the thermoplastic joining partner is surface activated by means of a plasma or flame treatment at least in the region of the joining zone. Said plasma treatment may preferably be carried out using air, oxygen or nitrogen as process gas. During this plasma treatment process, OH groups are accumulated on the surface of the plastic joining partner. These OH groups are then available for the formation of hydrogen bonds in the subsequent joining process. Along with the formation of these secondary valence bonds, a covalent bond is formed between the Si molecules in the glass and the OH group on the functionalized surface of the plastic material.

The strength of the bond can be increased even more by roughening the surface of the glass joining partner at least in the region of the joining zone. This structure, formed for instance by means of an ultrashort pulse laser at a pulse duration of <10 ns, causes the surface area involved in the bonding process to be increased substantially, thus resulting in an increased bonding effect between the molten thermoplastic material and these surface micro-structures and therefore in an increased joining strength of the bond.

Another preferred method is to measure the setting path that occurs when the two joining partners are joined together. This facilitates the reproducibility of the joining method.

A preferred parameter or the production of a seam-like joining zone is to move the laser processing beam across the boundary surface of the thermoplastic material at a feed rate of 2 mm/s to 100 mm/s. The joining force applied to the two joining partners in this process may amount to between 200 N and 800 N, preferably 400 N.

Some of the most essential advantages of the invention can once again be summarized as follows:
no consumables are required, such as a particular adhesive;
the joining process is easily controllable;
only one process step is required;
the method is able to produce fine, defined structures; and
an online process control system can be integrated into the joining apparatus.

Other features, details and advantages of the invention will be apparent from the ensuing description in which exemplary embodiments are explained in more detail with reference to the attached drawings.

### BRIEF DESCRIPTION OF THE DRAWINGS

FIG. 1 shows a diagrammatic, broken-open perspective view of a laser joining device and the two joining partners;

FIG. 2 shows a top view of the joining partners with an intact adhesive seam; and

FIG. 3 shows a top view of the thermoplastic joining partner after a forced separation of the adhesive seam.

### DESCRIPTION OF THE PREFERRED EMBODIMENTS

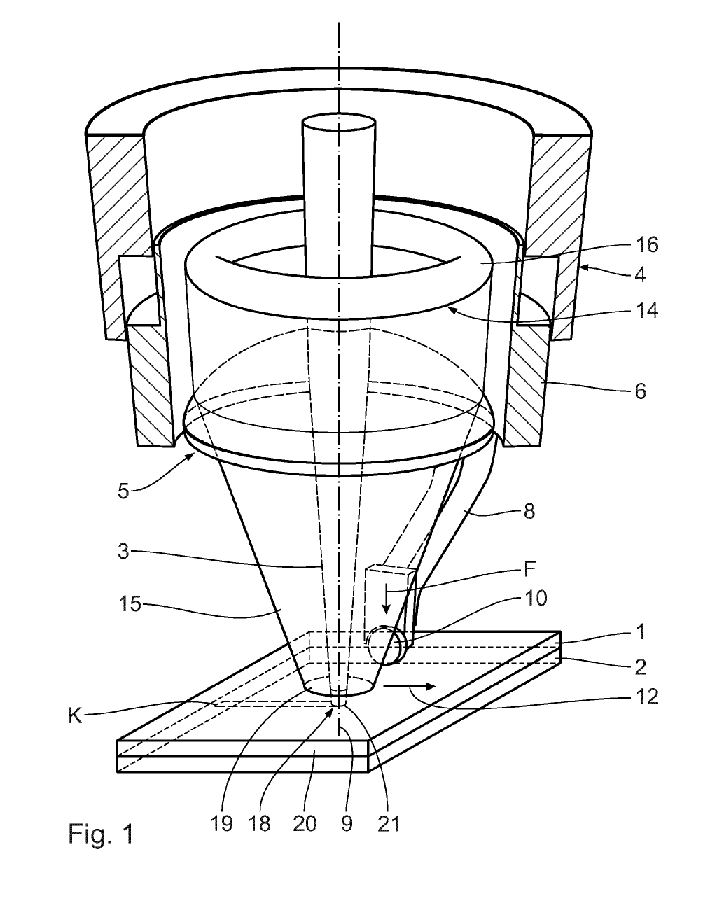

FIG. 1 shows two joining partners to be bonded together, namely a first glass joining partner 1 and a second thermoplastic joining partner 2. To perform this bonding process, a device is used which is also used for laser transmission welding. The upper glass joining partner 1 is transmissive of the laser processing beam 3 while the lower thermoplastic joining partner 2 is absorptive thereof. The remaining aspects of laser transmission welding are known and need no further explanation.

The laser processing beam 3 is guided, by means of a processing head designated by reference numeral 4 in its entirety, from a stationary laser beam source via a fiber optical system to the focussing optical system 5. Both laser beam source and fiber optical system are omitted in the drawings for the sake of clarity. The focussing optical system 5 is disposed on a carrier 6 of the processing head 4, which is for instance flanged to the manipulation arm of an industrial robot.

Via an arm 8, a tensioning roller 10 is mounted to the side of the optical axis 9 of the laser processing beam 3, the tensioning roller 10 rolling on the upper glass joining partner 1 with its circumference, thus causing the two joining partners 1, 2 to be clamped together in the region of the bond to be formed by applying a corresponding joining force F. For the sake of clarity, a corresponding counter holder for the roller mounted below the welding contour is not shown in FIG. 1 either.

Furthermore, an IR halogen radiator 14 is mounted to the carrier 6 of the processing head 4, the radiator 14 generating a short-wave secondary infrared radiation 15. The IR halogen radiator 14 is mounted in a secondary beam reflector 16 on the carrier 6. Due to the reflector 6, the secondary radiation 15 is emitted onto the joining zone 18 in a focussed manner. As can be seen from FIG. 1, the focal region 19 of the secondary radiation 15 is wider than the focus 21 of the laser joining beam 3, with the result that in the joining zone 18, the secondary radiation 15 causes the upper glass joining partner 1 to heat up concentrically around the focus 21.

The joining device described above allows the method according to the invention to be implemented as follows:

The thermoplastic joining partner 2 is prepared by plasma activation of its boundary surface 20 to be molten. The plasma used is a compressed air plasma, wherein it is not definitely clarified which components of air are ionized/radicalized during plasma generation. It is assumed that in this process, O²⁻ ions form OH groups (O—H; C—O—O—H; C—H—O; C—O—N—H₂) on the surface of the plastic material. This functionalization on the one hand causes the surface tension to increase while allowing covalent bonds to form due to the presence of the OH groups.

The two joining partners 1, 2 are then clamped into the device shown in FIG. 1.

The processing head 4 now moves, in the feed direction 13, across the joining contour K in which a bonding or adhesive seam is to be formed between the two joining partners, thus causing the tensioning roller 10 to act upon the two joining partners 1, 2, with the temperature of the upper glass joining partner 1 being increased locally in the respective joining zone 18 by means of the secondary radiation 15. At the same time, the laser processing beam 3 is emitted through the glass joining partner 1 and onto the boundary surface 20, facing the glass joining partner 1, of the thermoplastic joining partner 2, causing the thermoplastic joining partner 2 to melt locally. As a result, an intimate contact is obtained due to the formation of hydrogen bonds and micro-bonds between the two joining partners 1, 2, thus resulting in a hotmelt adhesive bond between the two joining partners 1, 2. The setting path occurring between the two joining partners 1, 2 when they are being joined together is measured and entered in the process control system as a significant parameter for the melting process. Once the two joining partners 1, 2 have cooled, which results in neglectable internal stresses in the joining zone 18 due to the temperature increase of the glass joining partner 1, a stable thermoplastic material-glass hotmelt adhesive bond is obtained between the two joining partners 1, 2.

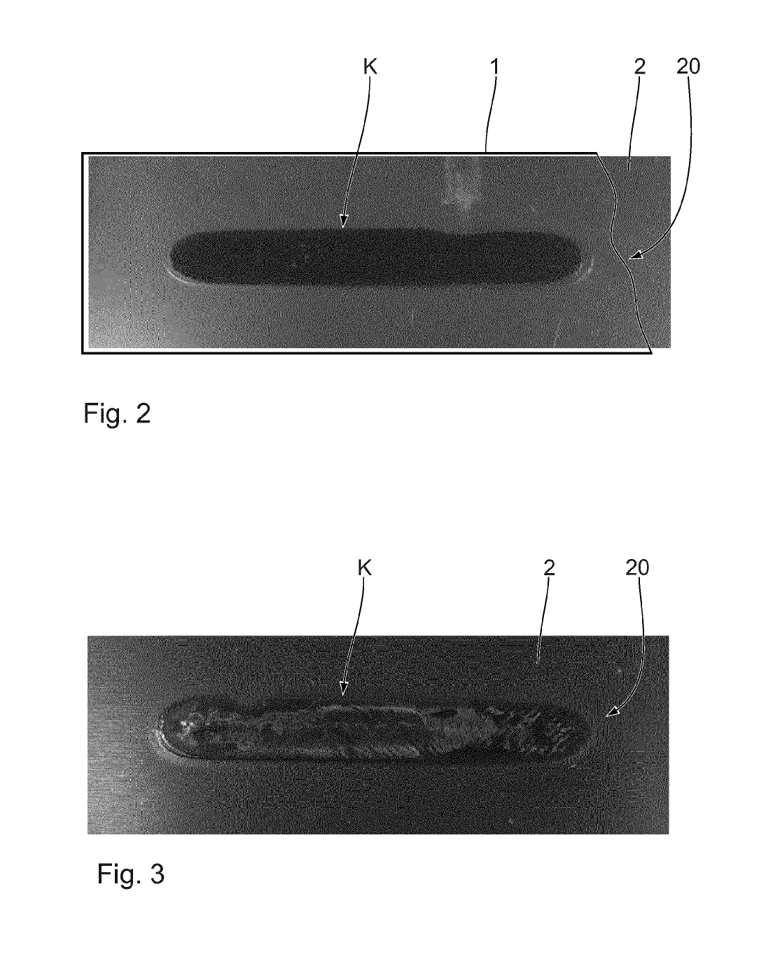

Experimental results of the joining method according to the invention shall be explained by means of FIGS. 2 and 3. FIG. 2 shows a top view of the two joining partners 1, 2 after producing a joining contour K in the form of a short hotmelt adhesive seam that presents itself as an even glossy black seam area in the boundary surface 20 of the lower thermoplastic joining partner 2. A strong adhesion can be determined, in other words there is a stable adhesive bond between the two joining partners 1, 2. FIG. 3 shows the boundary surface 20 of the thermoplastic joining partner 2 after forcefully removing the upper glass joining partner 1. As can be seen, there are disruptions in the thermoplastic material indicating the stability of the seam joint.

In the case discussed above, the glass joining partner 1 was made of standard BK 7 glass having a thickness of 5 mm while the thermoplastic joining partner 2 consisted of a combination of PC/ABS materials. The laser power was 28 W while the power of the secondary radiation was 1000 W. The feed rate v of the laser beam was set to 7 mm/s, and the joining force F used was 400 N.

The following table contains successful experiments for producing hotmelt adhesive seams between different thermoplastic materials and glass (BK7, thickness: 5 mm), the experiments having been conducted using the materials and parameters shown below:

| Thermoplastic | Laser | Halogen | Feed | Joining |
|---|---|---|---|---|
| material | power | power | rate | force |
| PC/PET | 28 W | 1000 W | 7 mm/s | 400 N |
| PC/ABS | 28 W | 1000 W | 7 mm/s | 400 N |
| PP | 14 W | 1000 W | 3 mm/s | 400 N |
| PA (Grilamid) | 24 W | 1000 W | 5.25 mm/s | 400 N |

During the experiment carried out using the thermoplastic material combination PC/PET, additional experiments were conducted to examine the effects of temperature changes on the joining partners 1, 2 bonded to each other. After three temperature changes within 30 to 60 minutes in a temperature range of −20° C. to 60° C., no disruption of the adhesive seam was observed.

1-14. (canceled)

15. A method for joining a joining partner of a thermoplastic material to a joining partner of glass, comprising the following method steps:
providing a thermoplastic joining partner of a laser absorbing thermoplastic material;
providing a glass joining partner of a laser transmissive glass material;
placing the thermoplastic joining partner and the glass joining partner on top of each other while applying a joining force to the joining partners;
increasing the temperature of the glass joining partner; and
emitting a laser processing beam through the glass joining partner onto the boundary surface of the thermoplastic joining partner and into a joining zone, thus causing the thermoplastic joining partner to melt so that an adhesive bond is formed in the joining zone between the two joining partners during the cooling thereof.

16. The method according to claim 15, wherein the temperature of the glass joining partner is increased using a radiation.

17. The method according to claim 15, wherein the material of the thermo-plastic joining partner is selected from the group comprising the following thermoplastic materials: polypropylene (PP), polyethylene (PE), acrylic nitrile butadiene styrene (ABS), acrylic ester styrene acrylic nitrile (ASA), polymethyl methacrylate (PMMA), polycar-bonate (PC), polyehtylene terephtalate (PETE), polyethereimide (PEI), polyamide (PA) and cyclo olefin copolymer (COC).

18. The method according to claim 15, wherein the material of the glass joining partner is selected from the group comprising the following glass materials: borosilicate glass, fused quartz, magnesium fluoride, hardened glass obtained by means of an ion exchange technique, and strengthened glass.

19. The method according to claim 18, wherein the strengthened glass is made of borosilicate glass.

20. The method according to claim 15, wherein the laser processing beam is an infrared laser beam.

21. The method according to claim 20, wherein the infrared laser beam has a wavelength of one of the group comprising 808 nm and 2000 nm.

22. The method according to claim 15, wherein the laser processing beam is provided with a laser power of 10 W to 200 W.

23. The method according to claim 15, wherein the radiation for increasing the temperature of the glass joining partner is generated by at least one halogen radiator.

24. The method according to claim 23, wherein the power of the halogen radiator amounts to between 500 W and 2000 W.

25. The method according to claim 24, wherein the power of the halogen radiator (14) amounts to 1000 W.

26. The method according to claim 15, wherein the thermoplastic joining partner is surface activated at least in the region of the joining zone by means of one of the group comprising a plasma treatment and a flame treatment.

27. The method according to claim 26, wherein during the plasma treatment one of the group comprising air, oxygen and nitrogen are used as process gas.

28. The method according to claim 27, wherein the air used as process gas is compressed air.

29. The method according to claim 15, wherein the surface of the glass joining partner is roughened at least in the region of the joining zone.

30. The method according to claim 29, wherein the glass joining partner is roughened by means of a laser exposure.

31. The method according to claim 30, wherein the glass joining partner is roughened by ultrashort laser pulses at a pulse duration of <10 ns.

32. The method according to claim 15, wherein the setting path occurring during the joining of the two joining partners is measured.

33. The method according to claim 15, wherein in order to produce a seam-like joining zone, the laser processing beam is moved across the boundary surface of the thermoplastic joining partner at a feed rate of 2 mm/s to 10 mm/s.

34. The method according to claim 15, wherein the joining force amounts to between 200 N and 800 N.

35. The method according to claim 34, wherein the joining force amounts to 400 N.
